(19) United States
(12) Patent Application Publication
(10) Pub. No.: US 2024/0246253 A1
(43) Pub. Date: Jul. 25, 2024

(54) SPRING ASSISTED ADJUSTABLE LOG REST AND CROSS BUNK

(71) Applicant: Norwood Industries Inc., Oro-Medonte (CA)

(72) Inventors: Ashlynne DALE, Oro-Medonte (CA); Sebastien CABRIT, Oro-Medonte (CA); Daniel VANDERHEYDEN, Oro-Medonte (CA)

(73) Assignee: Norwood Industries Inc., Oro-Medonte (CA)

(21) Appl. No.: 18/423,266

(22) Filed: Jan. 25, 2024

(30) Foreign Application Priority Data
Jan. 25, 2023 (CA) 3187800

(51) Int. Cl. B27B 29/02; B27B 29/04

(52) U.S. Cl. CPC B27B 29/02; B27B 29/04

(57) ABSTRACT

A log rest assembly for use in a portable sawmill has a log rest post mounted on a first end of a cylindrical mounting rod. The log rest post is fixed to a cylindrical log rest sleeve such that the log rest post remains perpendicular to said mounting rod. A stationary collar is affixed to the mounting rod. A compressible collar is mounted onto the mounting rod between said cylindrical log rest sleeve and said stationary collar. The compressible collar and the stationary collar provide pressure on the cylindrical log rest sleeve to constrain rotation of the log rest in relation to the mounting rod.

### FIELD

The present invention relates to a log support system (log rest) and cross bunk for a portable sawmill.

### CROSS-REFERENCE TO RELATED APPLICATION

This application claims priority from Canadian Application No. 3,187,800 filed Jan. 25, 2023, the contents of which are incorporated herein by reference.

### BACKGROUND OF THE INVENTION

A challenging aspect of sawmilling is properly securing the log in position, so that the log does not shift or rotate during milling. In order for the log to be secured effectively, multiple components are required—two or more vertical log rests against which the logs rests, one or more vertical log dogs which firmly hold and lock the log against the log rest(s), and multiple horizontal cross bunks as part of a log bed on which the log lays.

The log dog and log rest are fixed or releasably coupled to the log bed in order to hold the log in position on the log bed, as described in the applicant's prior patents CA3128969, CA2806456, CA2782909, CA2687623 and CA 3101140, the contents of which are incorporated herein by reference. The bed, log dog, and log rest collectively hold the log in place, effectively forming a 3 sided clamp for cutting along the fourth “side” of the log. If the face of the log that has already been cut is not flush with the log rest, it is not parallel to the horizontal cross bunks, producing inaccurately cut and unusable lumber.

As the log is cut, the diameter of the log decreases, and the log dog and log rest will interfere with the path of the saw if their position is not changed. Many log rests incorporate rotation around a fixed axis, in which the log rest can be rotated downwards as cutting progresses, so that it become oriented horizontally instead of vertically. When prior art log rests are fixed in position, they are secured in orientation directly with a bolt that prevents unwanted rotation during cutting.

When the prior art log rest needs to be rotated, the bolt can be manually loosened, and then manually tightened again when the log rest is in the desired position. However, this bolt can be overtightened, potentially leading to elastic deformation in the components. Additionally, vibrations or impacts can loosen the bolt, leading to undesired rotation and releasing a log that should remain secured for the duration of the cut. If the bolt is under tightened, the log rest will drop and fail.

Furthermore, known log rests are unable to be adjusted to ensures that they are square with the cross bunk, meaning that even minute changes in the orientation of either the cross bunk or log rest could potentially mean that the sawmill bed and/or log rest must be repaired, or even replaced all together.

Thus, there is a need in the art for a log rest that permits the operator to rotate the log rest around a fixed axis without the risk of damaging the components or risk of accidental rotation. Moreover, there is a need in the art for a log bed that can be adjusted and squared to prevent undesired movement or vibration during cutting.

### SUMMARY OF THE INVENTION

The invention teaches a log rest assembly for use in a portable sawmill having a log rest post mounted on a first end of a mounting rod by a cylindrical log rest sleeve such that the log rest post remains perpendicular to said mounting rod; a stationary collar affixed to said mounting rod; and a compressible collar mounted onto said mounting rod between said cylindrical log rest sleeve and said stationary collar. The compressible collar and said stationary collar provide pressure on said cylindrical log rest sleeve to prevent unintended rotation of said log rest.

The invention also teaches a log support and clamp assembly comprising the log rest assembly of claim 1 and a log dog mounted on an opposite end of said mounting rod, said log dog having a vertical portion generally perpendicular to said horizontal cross bunk, and a top end having a pick protruding therefrom.

The log support and clamp assembly may have a horizontal cross bunk for affixing to a sawmill, said cross bunk capable of being affixed to said sawmill at each end of said cross bunk and the mounting rod affixed parallel to said cross bunk, each end of said mounting rod affixed near each end of said cross bunk.

The log support and clamp assembly may have the horizontal cross bunk affixed at both ends to the sawmill through a set of sawmill support pieces, said sawmill support pieces permanently or semi-permanently affixed to said sawmill and attached to said horizontal cross bunk. It may be affixed is by one or more of a bolt, nut, screw, rivet or other fastener.

The compressible collar may be one or more of a spring, rubber, or other polymer.

In another embodiment, the invention teaches a horizontal cross bunk and log support and clamp assembly wherein the cross bunk capable of being affixed to said sawmill at a first end and an opposite end of said cross bunk. There may be a circular hole near the first end of said cross bunk to affix a first end of a mounting rod to said cross bunk and a cut out (cylindrical oblong/elongated hole) in said cross bunk near the opposite end of said cross bunk to affix an opposite end of said mounting rod parallel to said cross bunk. The opposite end of the mounting rod can be raised or lowered and can be secured to said cross bunk by affixing the opposite end of said mounting rod in said cut out. The affixing may be done by one or more of a bolt, nut, screw, rivet or other fastener.

The cutout may be a slot/oblong. The cutout may be oval.

The horizontal cross bunk and log support and claim assembly of the invention may have the log support and clamp assembly of the invention.

The invention also teaches a kit for the log rest assembly of claim 1, comprising the log rest post, the stationary collar, the compressible collar and instructions for assembly, as well as a kit for the log support and clamp assembly of the invention, comprising the log rest assembly, the log rest post, the stationary collar, the compressible collar, the log dog, and instructions for assembly.

The invention also teaches a sawmill comprising the log rest assembly of the invention, or the log support and clamp assembly of the invention, and a sawmill comprising the horizontal cross bunk and log support and clamp assembly of the invention.

### BRIEF DESCRIPTION OF THE DRAWINGS

FIG. 1 is a rear cross-section view of the log support cross bunk and log support system in isolation from the sawmill.

FIG. 2 is a front perspective view of the log support system of FIG. 1.

FIG. 3 is a rear perspective view of the log support system of FIG. 1.

FIG. 4 is a perspective view of the log rest tension system of the log support system of FIG. 1, in isolation

FIG. 5 is an exploded view of the log rest tension system of FIG. 4

FIG. 6 is a perspective view of the mounting rod.

FIG. 7 is a perspective view of a sawmill.

### DETAILED DESCRIPTION OF THE PREFERRED EMBODIMENTS

The present invention provides an effective log support system for a sawmill. The design of the log rest allows the user to easily rotate the log rest between a horizontal and vertical position, without requiring tightening and loosening of a pressure tab. As such, the user can quickly adjust the height of the log rest to compensate for the changing height of the log during milling, without risking deforming or damaging the sawmill or log rest sleeve.

The oval slot in the cross bunk allows the log rest to be easily squared with the cross bunk and log dog by a single user, using the cut-outs on the cross bunk. The bolt securing the log support system can be loosened and the log support system can then be adjusted and the bolt can be tightened again without damage to the assembly or factory repair.

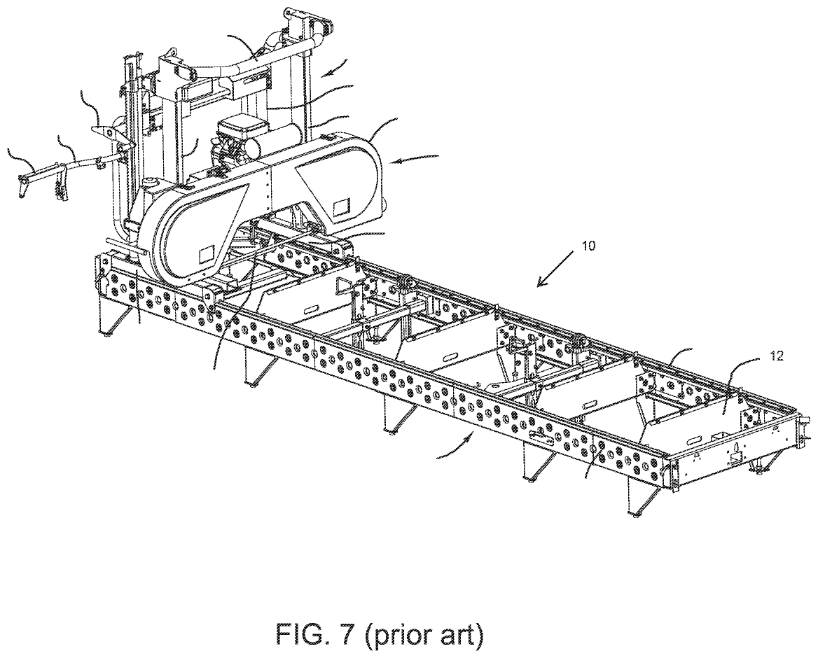

For context, FIG. 7 shows a typical sawmill with cross bunks 12 forming a sawmill bed 10.

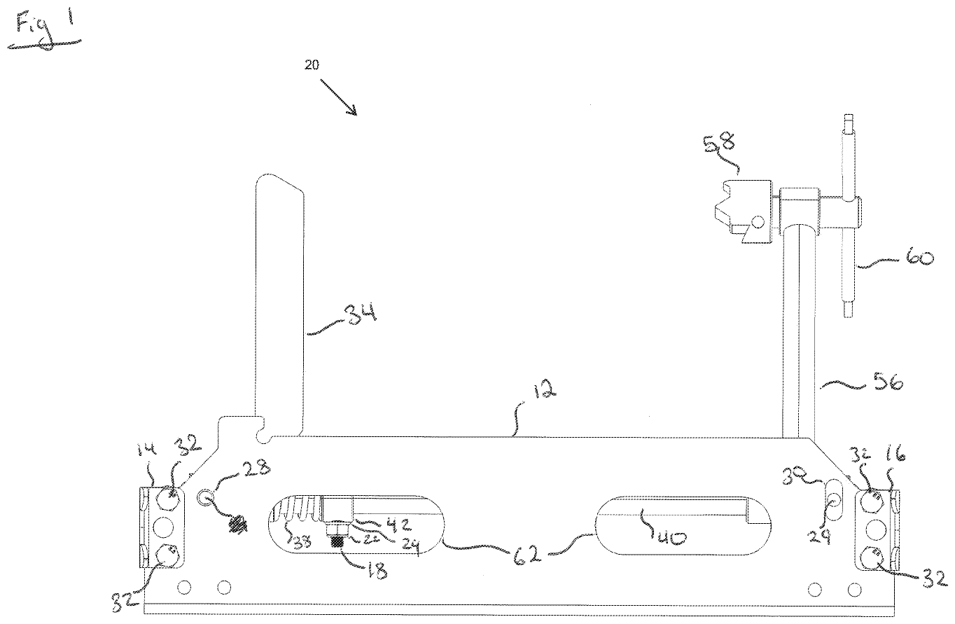

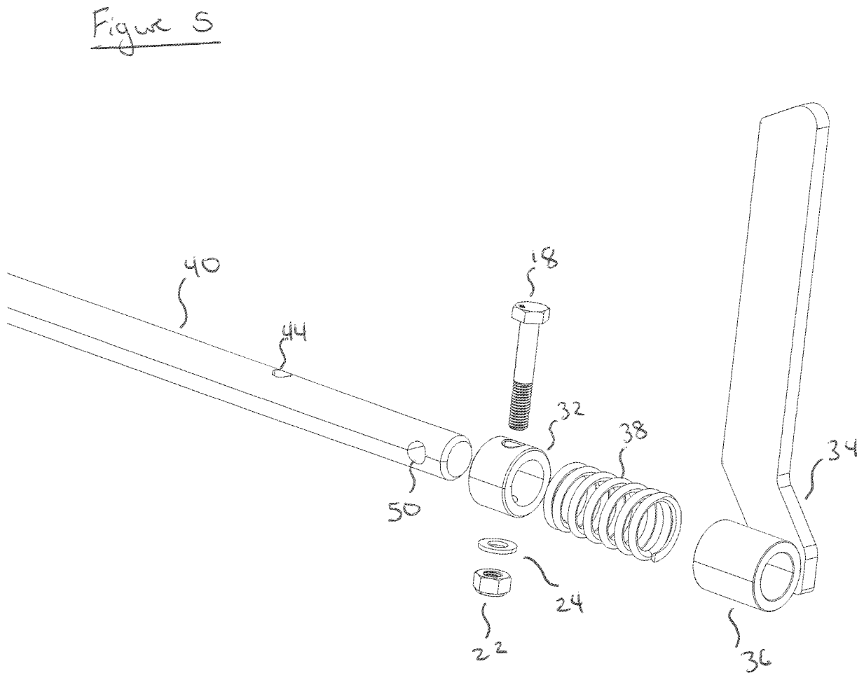

An embodiment of the present invention will now be described as shown in FIGS. 1-6.

As seen in FIG. 1, the log support system 20 comprises a cross bunk 12 designed to be affixed to the sawmill bed 10 through sawmill supports 14 and 16. The sawmill supports 14 and 16 are affixed to the cross bunk 12 through bolts 32 on both sides of the cross bunk 12. The design of the cross bunk 12 includes a round hole 28 near a first end and an oval slot 30 near an opposite end the to attach the cross bunk 12 to the mounting rod 40 seen through cross bunk cut outs 62. The oval slot 30 allows for the user to rotate the log support system 20 about the axis at a round hole 28 such that the cross bunk 12 can be easily leveled and squared by a single operator. A bolt and nut 29 can be tightened at oval slot 30 to secure the position of the cross bunk 12. In other embodiments, screws, rivets, or other fasteners can be used in place of the nuts and bolts.

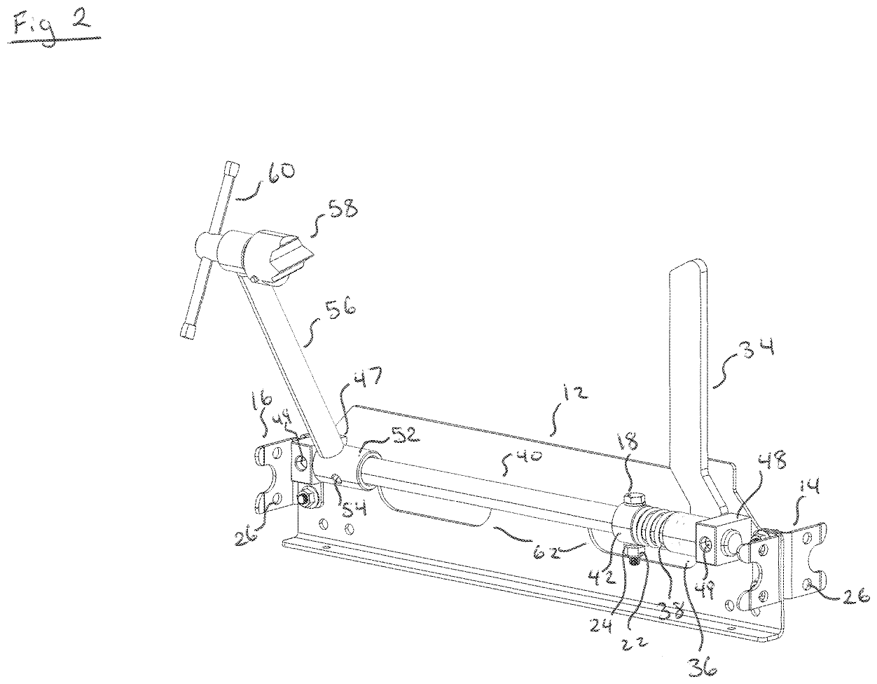

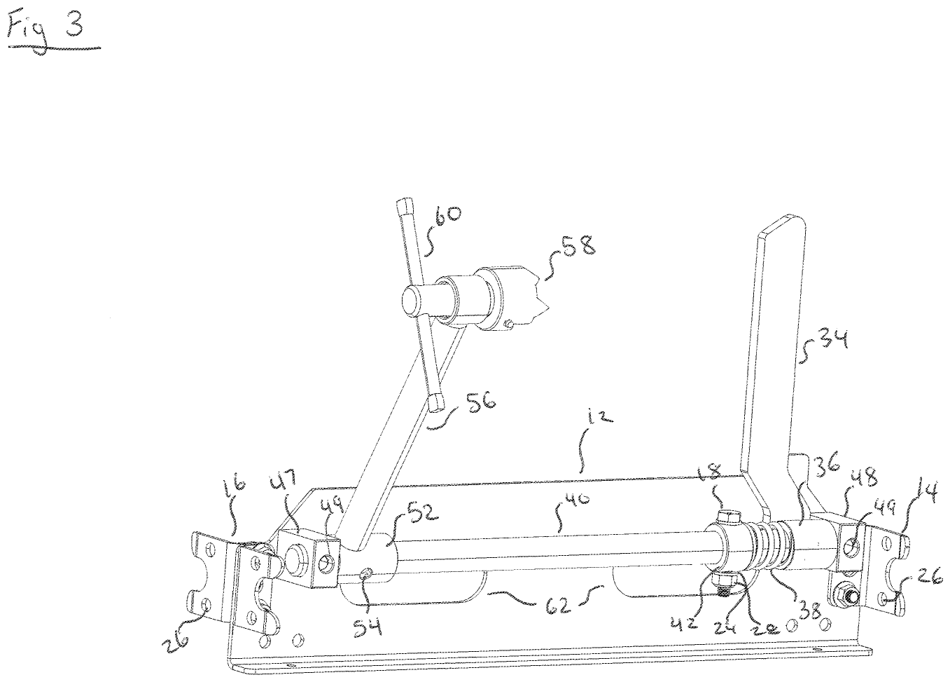

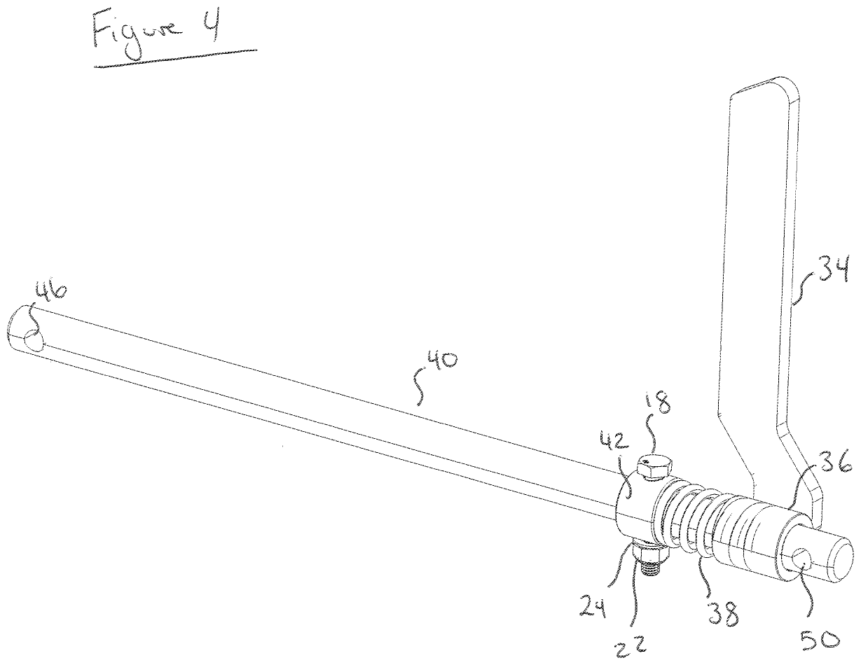

As seen in FIGS. 2-3, the sawmill supports 14 and 16 contain screw holes 26 to attach the supports to the sawmill bed 10 according to the previous paragraph. Log rest mounting blocks 47 and 48 are attached to the cross bunk 12 using screw holes 49 which line up with round hole 28 and oval slot 30. The rod 40 is secured in log rest mounting blocks 47 and 48 using bolts, screws, rivets, or other fasteners through rod holes 46 and 50 shown in FIG. 4. The log dog sleeve 52 is secured onto rod 40 via a screw hole 54, which can be tightened to secure log dog rod 56 in place, or not. When the sleeve 52 is not tightened, it can freely move perpendicular to rod 40 and can rotate about the axis of rod 40.

Typically, log dog rod 56 is rotated to be positioned based on the size of the log to be cut. This movement can be facilitated by use of the log dog rod handle 60. For larger logs, log dog rod 56 will be vertical and log dog sleeve 52 will be positioned towards the end of the mounting rod to allow for clamping of a wider log. If a smaller log is required to be clamped, log dog rod 56 can be rotated to lower the height of the pick 58 in relation to cross bunk 12, and the mount 52 can be moved closer towards log rest 34.

As seen in FIGS. 4-6, log rest collar 42 is secured to rod 40 using a bolt 18 and a washer 24 and nut 22, bolt 18 going through log rest collar hole 44 and rod hole 46. The positioning of log rest collar 42 is such that spring 38 produces a certain constant pressure on log rest sleeve 36, the pressure keeping the positioning of log rest 34 rotatably secure while still allowing an operator to adjust the positioning when desired. Both spring 38 and log rest sleeve 36 assembled onto rod 40, and are not secured by a screw, bolt, rivet or other fastening means.

In other embodiments, a rubber, PVC, or compressible and elastic polymer can be used in place of spring 38 to apply tension to the log rest sleeve 36. In other embodiments, a friction washer may be used.

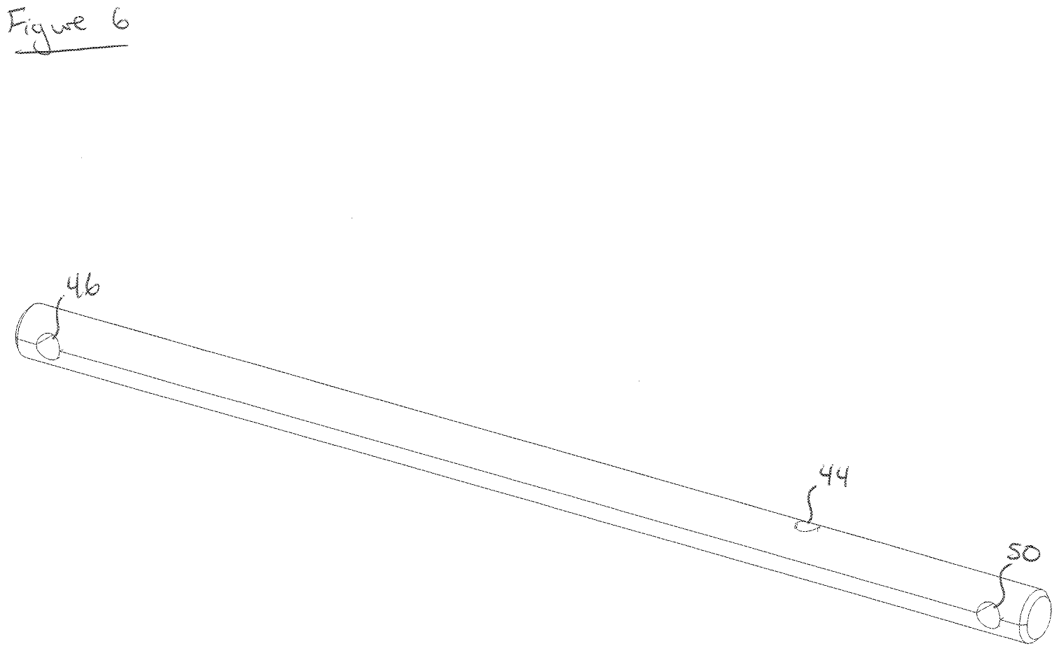

As seen in FIG. 6, mounting rod 40 contains three through holes. Through holes 46 and 50 secure the rod in position and attach the rod to cross bunk 12 and log rest mounting blocks 47 and 48, preventing any rotation in the mounting rod 40. Through log rest collar hole 44 is used to secure the log rest collar 42, which keeps a constant pressure on spring 38.

It is to be understood that the present invention is not limited to the embodiments described above, but encompasses any and all embodiments within the scope of the following claims.

1. A log rest assembly for use in a portable sawmill, comprising:
a log rest post mounted on a first end of a cylindrical mounting rod said log rest post fixed to a cylindrical log rest sleeve such that the log rest post remains perpendicular to said mounting rod;
a stationary collar affixed to said mounting rod;
a compressible collar mounted onto said mounting rod between said cylindrical log rest sleeve and said stationary collar;
wherein said compressible collar and said stationary collar provide pressure on said cylindrical log rest sleeve to constrain rotation of said log rest in relation to said mounting rod.

2. A log support and clamp assembly comprising the log rest assembly of claim 1 and a log dog mounted on an opposite end of said mounting rod, said log dog having a vertical portion generally perpendicular to a horizontal cross bunk, and a top end having a pick protruding therefrom.

3. The log support and clamp assembly of claim 2 further comprising:
a horizontal cross bunk for affixing to a sawmill, said cross bunk capable of being affixed to said sawmill at each end of said cross bunk;
wherein the mounting rod is affixed parallel to said cross bunk, each end of said mounting rod affixed near each end of said cross bunk.

4. The log support and clamp assembly of claim 2, wherein, in a loosened position the log dog is horizontally displaceable along the horizontal mounting rod, and in a tightened position the log dog is horizontally fixed along the horizontal cross bunk.

5. The log support and clamp assembly of claim 2 wherein, in a loosened position the log dog is rotatable about the axis of the mounting rod, and in a tightened position the log dog is fixed about the axis of the mounting rod.

6. The log support and clamp assembly of claim 2 wherein the horizontal cross bunk is affixed at both ends to the sawmill through a set of sawmill support pieces, said sawmill support pieces permanently or semi-permanently affixed to said sawmill and attached to said horizontal cross bunk.

7. The log support and clamp assembly of claim 2 wherein the affixing is by one or more of a bolt, nut, screw, rivet or other fastener.

8. The log support and clamp assembly of claim 2 wherein the stationary collar is secured by one or more of a bolt, nut, screw, rivet or other fastener.

9. The log support and clamp assembly of claim 2 wherein the compressible collar is one or more of a spring, friction washer, rubber, PVC or other polymer.

10. The log support and clamp assembly of claim 2 wherein the compressible collar constrains rotation of said log rest to the extent that significant manual force is required to rotate said log rest.

11. A horizontal cross bunk and log support and clamp assembly comprising:
the cross bunk capable of being affixed to said sawmill at a first end of said cross bunk and at an opposite end of said cross bunk;
a circular hole near the first end of said cross bunk to affix a first end of a mounting rod to said cross bunk;
a cut out in said cross bunk near the opposite end of said cross bunk to affix an opposite end of said mounting rod parallel to said cross bunk;
whereby said opposite end of the mounting rod can be raised or lowered and can be secured to said cross bunk by affixing the opposite end of said mounting rod in said cut out; and
the log support and clamp assembly of claim 2.

12. The horizontal cross bunk and log support and clamp assembly of claim 11 wherein the cutout is a slot.

13. The horizontal cross bunk and log support and clamp assembly of claim 11 wherein the cutout is oval.

14. A kit for the log rest assembly of claim 1, comprising the log rest post, the stationary collar, the compressible collar and instructions for assembly.

15. A kit for the log support and clamp assembly of claim 2, comprising the log rest assembly, the log rest post, the stationary collar, the compressible collar, the log dog, and instructions for assembly.

16. A sawmill comprising the log rest assembly of claim 1.

17. A sawmill comprising the horizontal cross bunk and log support and clamp assembly of claim 11.

18. A sawmill comprising the log support and clamp assembly of claim 2.
